(19) United States
(12) Patent Application Publication
(10) Pub. No.: US 2013/0188852 A1
(43) Pub. Date: Jul. 25, 2013

(54) ACQUISITION DEVICE AND A METHOD FOR CONTROL THEREOF

(71) Applicants: Annemarie Bakai, Erlangen (DE); Patrick Gross, Langensendelbach (DE)

(72) Inventors: Annemarie Bakai, Erlangen (DE); Patrick Gross, Langensendelbach (DE)

(21) Appl. No.: 13/743,539

(22) Filed: Jan. 17, 2013

(30) Foreign Application Priority Data
Jan. 20, 2012 (DE) 102012200782.2

(51) Int. Cl. G06T 7/00

(52) U.S. Cl. CPC G06T 7/0012
USPC 382/131; 382/128

(57) ABSTRACT

In a method to control a second image acquisition device to acquire a second image data set to be jointly evaluated (in particular to be merged) with a first image data set acquired with a different, first image acquisition device that uses a different imaging method than the second image acquisition device, at least one item of setting information is extracted from the first image data set and/or a metadata set) associated with the first image data set, and from the setting information at least one acquisition parameter is determined in order to acquire the second image data set and/or for a planning image data set that prepares the acquisition of the second image data set. The second image acquisition device is controlled using the acquisition parameter so as to acquire the second image data set and/or the planning image data set.

### BACKGROUND OF THE INVENTION

1. Field of the Invention

The invention concerns a method to control a second image acquisition device to acquire a second image data set to be evaluated (in particular to be merged or fused) together with a first image data set that is acquired with a different, first image acquisition device that utilizes a different imaging modality than the second image acquisition device. The invention also concerns an image acquisition device of the type.

2. Description of the Prior Art

Particularly in the field of medicine, it is ever more often the case that exposures of a subject (in practice a patient in medicine) are acquired with multiple different imaging methods (consequently different imaging modalities). For example, a first image data set acquired with a first imaging modality should be merged with an image data set acquired with a second imaging modality.

As an example, this occurs in the planning of a radiation therapy treatment (RT treatment). There, magnetic resonance images (consequently a second image data set) are acquired in addition to the planning computed tomography exposures (consequently a first image data set). Within the scope of the exposure planning, the two image data sets are merged so that the additional image information delivered by the magnetic resonance exposure can be associated in an anatomically correct manner, and the structures relevant to the planning can be established using the combined image information. In order to be able to plan well with multiple modalities, in order to facilitate the merging of the image data sets, it is important that the image data sets are “similar” to one another with regard to the desired use, for example have the same or a similar resolution and/or show the same or a similar acquisition region (field of view).

In order to enable this, it is known (for example in a clinic) to use routing cards that—in the example of radiation therapy treatment—are created by an RT department (radiotherapy department) and list what is to be heeded in the planning acquisitions. A user (an MTA, for example) then enters corresponding values for the acquisition parameters at the control panel at the computed tomography image acquisition device (here the first image acquisition device), which occurs analogously at the magnetic resonance image acquisition device (the second image acquisition device). However, the repeated input of acquisition parameters takes time and is error-prone. Incorrect, undetected acquisition parameters can lead to the situation that the acquisition must be repeated or that there are difficulties in the joint evaluation of the image data sets, in particular given a merging of the image data sets. Furthermore, it is well known to imaging system operators that the information recorded on the routing cards cannot necessarily be used analogously for different image acquisition devices. A computed tomography image acquisition device frequently calls for entirely different parameters in an entirely different format than a magnetic resonance image acquisition device, such that a significant transferal capacity is expected of the operator, who must roughly estimate how the acquisition parameters to be specified appear so that the desired similarity or preparation for joint evaluation is provided in order for a joint evaluation to be possible without errors in a simple manner. Particularly in a magnetic resonance device (which is frequently used as a second image acquisition device), problems occur because defined limits, that do not allow the realization of every specification with regard to the resolution and the like, are often placed on acquisition parameters.

### SUMMARY OF THE INVENTION

An object of the invention is to provide a method to acquire the second image data set, which (under ideal utilization of existing information) generates a second image that is particularly well suited for additional use within the scope of a joint evaluation.

This object is achieved by a method of the aforementioned wherein, according to the invention, the following steps are implemented:
extraction of at least one item of setting information from the first image data set and/or a metadata set associated with the first image data set,
determination from the setting information of at least one acquisition parameter to acquire the second image data set and/or of a planning image data set preparing the acquisition of the second image data set, and
controlling the second image acquisition device using the acquisition parameter to acquire the second image data set and/or the planning image data set.

The method according to the invention, which can, for example, be implemented completely automatically by a control device of the second image acquisition device, allows automatic setting information to be extracted by analysis of the first image data set or of metadata associated with the first image data set. The automatic setting information allows the determination of acquisition parameters to acquire the second image data set or of a planning image data set preparing the acquisition of the second image data set. For this purpose, it is only necessary to provide the first image data set and/or the metadata in the form of the metadata set from the first image acquisition device to the second image acquisition device, such that at least a portion of the acquisition parameters can be wholly automatically deduced for the second image data set. Knowledge that previously had to be transported laboriously and in abstract form by routing cards, and had to first be laboriously specified by an operator is thus provided to the second image acquisition device, which thus “knows” that a primary image data set already exists, and the primary image data set is also wholly automatically evaluated by the second image acquisition device in order to automatically determine acquisition parameters and use them to control the second image acquisition device to acquire the second image data set or the planning image data set.

The acquisition parameter or acquisition parameters are consequently determined automatically so that an optimal joint evaluation is enabled, which means that the method according to the invention can explicitly include an optimization process that is set up for an optimal comparability and/or joint evaluation capability of the two image data sets. In particular, the determination of the acquisition parameters can consequently take place so that the first image data set and second image data set have the same resolution and/or a comparable contrast and/or have an essentially corresponding (in particular coinciding) acquisition region. For example, it is thus possible (in particular with regard to a merging) to generate “similar” first and second image data sets as described above, so the joint evaluation of these data sets is consequently simplified (in particular is optimally possible).

In an embodiment of the present invention, at least one of the at least one acquisition parameters is determined depending on at least one item of usage information pertaining to the joint evaluation of the image data sets. In the determination of the acquisition parameters (and possibly already in the determination of the setting information), the desired connection between the two image data sets is consequently already taken into account so that an optimization with regard to the joint evaluation can take place in the sense described above. For example, with regard to a merging of the first and second image data sets, image data sets of a similar (or in particular coinciding) resolution and/or of a similar (or in particular coinciding) field of view are provided.

It should be noted that at least one of the at least one acquisition parameters can be adapted depending on a user input, in particular after a presentation of the at least one acquisition parameter determined from the setting information. Ultimately, the user is thus free as to whether he or she would actually like to use the at least one acquisition parameter (which is to be understood as a suggestion) without modification for acquisition with the second image acquisition device. For example, for this purpose, the extraction of the setting information and the determination of the at least one acquisition parameter can take place in advance of the acquisition, after which the determined acquisition parameters can be displayed to the user as presets in corresponding input fields that he or she can confirm or modify as needed. For example, an additional review by the user can thus take place.

In general, the present invention offers the advantage that the automatically generated suggestions for acquisition parameters—which suggestions take into account the “history” with regard to the first image data set, and possibly the “future” in the form of the usage information—facilitate, accelerate or at least partially (or completely) automate the preparation of the acquisition of the second image data set. The probability of an incorrect input is reduced, and the later joint evaluation is already advantageously assisted at this point.

The method according to the invention can be used particularly advantageously when the first image acquisition device is a CT image acquisition device and the second image acquisition device is an MR image acquisition device, or the first image acquisition device is an MR image acquisition device and the second image acquisition device is a CT image acquisition device. As already mentioned, it is within the scope of known radiation therapy treatments to use both a computed tomography image data set (CT image data set) and a magnetic resonance image data set (MR image data set) for planning, wherein the two image data sets should then be merged. The CT image data set is thereby frequently initially acquired as a first image data set. The method according to the invention now offers the possibility to inform the second image acquisition device (thus the MR image acquisition device) of the prior acquisition, and on the basis of this knowledge, to automatically determine acquisition parameters for the second image data set (namely the MR image dataset) and apply these accordingly.

For example, the resolution of the first and/or the second image data set, and/or the size and position of the field of view of the first and/or second image data set, and/or planning image data set, and/or information describing at least one slice of the first and/or second image data set and/or planning image data set, and/or at least one item of information pertaining to the contrast of the first and/or second image data set, can be determined as setting information and/or as acquisition parameters. Naturally, within the scope of the present invention it is also possible to determine or adapt other acquisition parameters, in particular when a better suitability of the second image data set for use within the scope of the joint evaluation is provided via their targeted selection. In particular, acquisition parameters can also be transferred from the first image data set to the second image data set, for example the size and position of the field of view and/or the resolution, such that the first and second image data set here can ultimately correspond or the like.

In a further embodiment, at least one acquisition parameter enabling a comparable positioning of a patient in the acquisition of the first and second image data set—in particular a setting of a patient bed and/or an item of information relating to the use of at least one bearing means that is already used in the acquisition of the first image data set in the acquisition of the second image data set—is determined. In particular, the second image acquisition device is controlled to output a position information to an operator and/or to automatically position the patient. It is thus possible to also convey a positioning of the patient at the second image acquisition device, which positioning is beneficial to a joint evaluation of the image data sets and/or also allows a particularly simple acquisition of the second image data set with the second image acquisition device, such that the same field of view is acquired, for example. A porting/reuse of information with regard to the first image data sets also can take place with regard to employed auxiliary means for patient positioning (concrete patient bearing means) so that patients are consistently born by bearing means in comparison between the two image data sets (for example in the measurement for an exposure planning). A measurement position in an imaging modality also can be transferred in this way to a second imaging modality. For example, in the event that the patient bearing means cannot be automatically controlled and used by the second image acquisition device, a positioning instruction can be output to a user that shows the correct use of the patient bearing means such that the attitude of the patient corresponds to the attitude in the acquisition of the first image data set. If the positioning can also be reestablished with regard to the specific attitude of the patient, not only can the image data sets thus clearly be better jointly evaluated but additional acquisition parameters can also be deduced from setting information under consideration of this same positioning, for example. For example, slice positions in magnetic resonance imaging can thus be derived directly from the first image data set (in particular a CT image data set) without a laser positioning and/or a planning image of the magnetic resonance needing to be used to plan the sequences. As a consequence, the assisted identical positioning of the patient that is provided in this extremely advantageous embodiment of the method according to the invention thus still allows the transfer of a number of additional acquisition parameters from the first image data set to the second image data set, and clearly limits the technical cost in the preparation of the acquisition of the second image data set.

In a further embodiment of the present invention, at least one item of setting information is determined by evaluating the first image data set. It is thus possible to provide an immediate evaluation of the image data of the first image data set in order to obtain setting information that, for example, are not available as metadata. For example, the resolution of an image data set can be determined from the image data set itself, wherein an evaluation of the image content itself can, advantageously take place within the scope of the present invention. For example, information regarding the field of view can be determined in the acquisition of the first image data set, for example in that anatomical features and/or structures in the first image data set are identified within the scope of a segmentation and/or an elastic registration with an anatomical atlas or the like, such that the imaged region (and consequently the field of view) can be determined from these. The first image data set can also be advantageously evaluated to the effect that, for example, employed bearing means and their position can be identified from the first image data set via an automatic image evaluation. Instructions about the positioning of the patient—in particular his attitude—can also be determined from the first image data set via the image evaluation, in particular also with regard to the elastic registration with an atlas and the like.

It is also possible that the first image data set to be stored in the DICOM format with at least one metadatum which is read out as setting information. The DICOM (digital imaging and communication in medicine) standard can thus also be used particularly advantageously within the scope of the present invention. Acquisition parameters of the first image data set or other metadata are frequently stored anyway in the DICOM format together with the first image data set, which means that the metadata set is ultimately already included in the first image data set. This additional information can now be read out and continue to be maintained in order to derive acquisition parameters from this for the second image data set, in particular also via adoption of acquisition parameters of the first image data set that are read out as setting information. The DICOM standard also advantageously offers the possibility to define a DICOM metadatum itself, such that even auxiliary information that is not provided in the actual standard can be stored. Within the scope of the present invention, at least one self-defined DICOM metadatum can be used, in particular with regard to the patient positioning and/or with regard to a patient bearing means. Additional information that is useful with regard to an acquisition of the second image data set that is adjusted for the joint evaluation can be transmitted to the second image acquisition device in this way.

The first image data set and/or the metadata set can be transferred to the second image acquisition device and/or that the second image acquisition device accesses the first image data set and/or the metadata set via a communication connection. A communication connection (in particular a network) is thus provided via which the information of the first image data set are provided to the second image acquisition device. For example, this connection can be the intranet of a medical facility (a clinic, for example).

In this context, the first and/or second image data set can be stored in an image archiving system that forms part of an information system. Image archiving systems are known in the art, for example under the designation PACS (picture archiving and communication system). In larger facilities (for example clinics) such image archiving systems are frequently used in order to be able to access acquired image data sets from multiple positions. Because the first image acquisition device and the second image acquisition device are connected to such an image archiving system, the second image acquisition device consequently has access to the first image data set and/or the metadata set. Such an image archiving system can in particular also be realized as part of an information system, for example a radiology information system and/or a hospital information system. Such information systems are known in the prior art and can advantageously be used with regard to the networking of the first image acquisition device with the second image acquisition device. The second image acquisition device thus ultimately accesses the first image data set and/or the metadata set via the image archiving system.

In an advantageous embodiment of the invention, the first image data set is used as a possible additional planning image data set in an operating mode for automatic slice position adaptation of the second image acquisition device and/or the planning image data set acquired with the acquisition parameters is evaluated in the operating mode for automatic slice position adaptation. Operating modes for automatic slice position adaptation (which are often also designated as an “auto-align mode”) are a technology that promotes the direct use of the acquisition information of a first image data set in a second imaging modality.

Such an operating mode for automatic slice position adaptation (thus an auto-align mode) uses detection software that detects the corresponding desired slice positions in a 3D image data set automatically using anatomical structures or the like (normally using an image atlas). Such auto-align modes are known primarily from magnetic resonance devices.

According to the invention, the setting information can be used in an operating mode for automatic slice position adaptation, which is possible together with the above-described identical positioning (in particular with regard to the attitude) of the patient. In one case it is possible to use the first image data set as setting information in its entirety, by this first image data set being accepted as a planning image data set (possibly also as an additional planning image data set in the event that a planning image data set should be acquired anyway using the acquisition parameters). The acquisition of a dedicated planning image data set with the second image acquisition device can be omitted in this case. However, it is also alternatively possible to use the setting information in order to acquire a planning image data set with the second image acquisition device, which planning image data set is then used for an auto-align process. Functionalities of the second image acquisition device that are present anyway are hereby consequently used in order to improve, automate and accelerate the entire preparation process for the acquisition of the second image data set.

Limitations of the values of the acquisition parameter that are provided in the determination of the acquisition parameter from the setting information can be taken into account in the second image acquisition device. As already mentioned, the problem frequently arises (in particular given magnetic resonance image acquisition devices as a second image acquisition device) that specific acquisition parameters are situated in specific, predetermined ranges since other values of acquisition parameters are technically unrealizable and the like. Such limitations can be taken into account within the scope of the method according to the invention, by—when at least one acquisition parameter cannot be selected as desired—the acquisition parameter and/or possibly also other acquisition parameters is adapted altogether so that a solution optimally close to the desired solution is present for the acquisition of the second image data set. In particular, a permitted selection of the acquisition parameter is made that is optimized with regard to the type of joint evaluation (advantageously described by the usage information).

In an embodiment in which a direct adoption of acquisition parameters is desired, for example, it can initially be sought to adopt acquisition parameters of the first image data set, for example, whereupon a type of plausibility check takes place in which it is established whether the acquisition parameters can be realized at all with the second image acquisition device. If this is not the case, an optimization algorithm is used in order to generate a suggestion for acquisition parameters that is allowed for the second image acquisition device and that is optimally well suited with regard to the joint evaluation.

The present invention also encompasses an image acquisition device that has a control device designed for implementation of the method according to the invention. All embodiments with regard to the method according to the invention can analogously be transferred to the image acquisition device according to the invention, with which these same advantages can consequently be achieved. In particular, a communication interface is provided to the second image acquisition device, which communication interface allows the receipt or the querying of the first image data set and/or of the metadata set, in particular via a connection to an image archiving system or the like. The control device evaluates the first image data set with regard to the setting information, automatically determines the acquisition parameters, and can then bring the acquisition parameters to the attention of a user (for example as a suggestion), wherein—if this user accepts the suggestion—an automatic control of the corresponding components of the image acquisition device takes place in order to realize the acquisition parameters.

### BRIEF DESCRIPTION OF THE DRAWINGS

FIG. 1 is a flowchart of an exemplary embodiment of the method according to the invention.

FIG. 2 schematically illustrates a system with an image acquisition device according to the invention.

### DESCRIPTION OF THE PREFERRED EMBODIMENTS

In this exemplary embodiment, the present invention is described in detail for the case of planning a radiotherapy treatment in which a CT image data set and an MR image data set are to be evaluated jointly by a merging (fusion) to plan the radiotherapy treatment.

In Step 1, a CT image data set as a first image data set 2 is initially acquired with a CT image acquisition device as a first image acquisition device. The first image data set 2 is generated in the DICOM format, which means that a metadata set 3 with additional information (for example acquisition parameters of the first image data set 2) is already included in the first image data set 2. Moreover, separate metadata tags can also be defined in the DICOM format, in which separate metadata tags corresponding information is stored, in particular with regard to the patient positioning and possibly the bearing means that are used.

The first image data set 2 is then provided in a hospital information system 4 which also comprises an image archiving system (PACS) 5. The magnetic resonance image acquisition device as a second image acquisition device is also connected to the hospital information system 4, and consequently the image archiving system 5, such that the first image data set 2 with the metadata set 3 can be retrieved in Step 6.

Setting information are now extracted from the first image data set 2 and the metadata set in Step 7, from which setting information acquisition parameters 9 regarding the acquisition of a planning image data set 10 and/or of the second image data set 11 with the second image acquisition device are then determined in Step 8. A usage information 12 is thereby taken into account, here information that describes the desired merging of the first image data set 2 with the second image data set 11. The determination of the acquisition parameters 9 finally takes place with regard to this desire merging since the two image data sets 2, 11 should be optimally similar—in particular in terms of their resolution and the position and size of their field of view—for merging.

At this point it is noted that Steps 7 and 8 can also be interleaved with one another, for example if acquisition parameters are realized successively depending on settings or the like and/or acquisition parameters 9 require other acquisition parameters as a requirement for their determination and the like. This is now explained in detail in a few examples.

First, it is noted that there are multiple possibilities for the extraction of the setting information from the first image data set 2 in Step 7. On the one hand, it is possible that the first image data set 2 (in particular its image data themselves) are evaluated to determine the setting information (or at least a portion of the setting information) itself. For example, it is thus conceivable to derive the resolution of the first image data set 2, the field of view of the first image data set 2, the position (in particular the attitude) of the patient at the acquisition of the first image data set 2, directly from the image data of the first image data set 2. Analysis algorithms, segmentation algorithms and registration algorithms (in particular with regard to an anatomical atlas) can be used for this purpose.

However, it is also possible to read or derive setting information from the metadata because these frequently include information that is important with regard to the acquisition of the second image data set 11, specifically if the desired join evaluation (here via merging) is considered.

At this point it should be emphasized that even the entire first image data set 2 can be used as setting information in a variant of the method according to the invention, namely when this is used as a planning image data set (instead of the acquisition of a specific planning image data set with the second image acquisition device) for a mode for automatic slice position adaptation (auto-align mode). In such an operating mode for automatic slice position adaptation (which can be realized in magnetic resonance image acquisition devices, for example), acquisition parameters which enable an optimal imaging of specific organs or anatomical structures are automatically proposed based on planning image data. For example, the direction, the number of slices, the field of view, the slice thickness and the like can be selected so that cardinal directions and coverages are set optimally in target organs or target structures such as head, spinal column, heart and the like. Planning image data are required for this, wherein it is conceivable to directly use the first image data set 2 for this.

In particular, this is advantageous when such acquisition parameters that allow an essentially identical positioning of the patient in the second image acquisition device as he was positioned in the first image acquisition device (which also pertains to the use of bearing means and the concrete attitude of the patient) have already been determined as additional acquisition parameters. A patient position may be partially reestablished via the absolute positioning, for example consequently via control of a patient bed of the second image acquisition device; however, to reproduce a specific attitude of the patient it can also be possible within the scope of the method according to the invention to identify bearing means and the like that are used, as well as to generate from these a positioning information that can be output to a display device of the second image acquisition device. A user can then correctly establish the orientation. In such an example, as has already been presented the first image data set 2 can be particularly advantageously used as a planning image data set in an auto-align mode, from which additional acquisition parameters 9 then follow for the second image data set 11.

However, it is also alternatively possible to determine acquisition parameters 9 for a planning image data set 10, in particular a planning image data set that is used in an auto-align mode, consequently a planning image data set 10 preparing the acquisition of the second image data set 11. With regard to the organ of interest and the like, acquisition parameters 9 can be selected for the planning image data set 10, wherein the selection of other acquisition parameters can also be determined depending on the prior knowledge of the first image data set 2.

It is further noted that, in the magnetic resonance device (considered here as a second image acquisition device) it can occur that specific acquisition parameters 9 or combinations of acquisition parameters 9 are unrealizable because certain limits or, respectively, thresholds must be maintained. For example, if it is thus provided to adopt the resolution and the field of view of the first image data set 2 for the second image data set 11 as well, it can occur that this is not possible due to such limitations of the acquisition parameters 9. In this case—in particular within the scope of an optimization process—an allowed combination of acquisition parameters 9 is sought that comes optimally close to the desired result.

As is apparent, in the method according to the invention the acquisition parameters 9 are determined in Step 8 under consideration of the usage information 12 so that an optimal common evaluation is enabled, presently such that the first image data set 2 and the second image data set 11 have a comparable (in particular the same) resolution and essentially corresponding (in particular coinciding) acquisition regions.

The orientation of the image data sets 2 and 11 also can be at least similar, ideally coinciding.

If the acquisition parameters 9 are determined first, if a planning image data set 10 should be acquired the second image acquisition device is thus controlled to acquire the planning image data set 10 corresponding to the acquisition parameters for the planning image data set (Step 13). The planning image data set 10 can then (Arrow 14) be used in order to determine additional acquisition parameters 9 for the second image data set 11, or be taken directly into account in the control using the acquisition parameters 9 for the second image data set 11 in Step 15. As mentioned, the acquisition of a planning image data set is optional, and in particular is unnecessary when the first image data set 2 can, for example, be used directly as a planning image data set in an auto-align mode.

Because the second image data set 11 (which naturally can also be provided via the image archiving system 5) has been adopted via the control in Step 15, in Step 16 the joint evaluation of the image data sets 2, 11 (here the merging) can take place under optimal requirements because the second image data set 11 has been acquired so that it has taken into account the information of the first image data set 2 and consequently is particularly well suited for fusion, in particular is similar to the first image data set 2 in terms of its resolution, its orientation and its acquisition region (field of view).

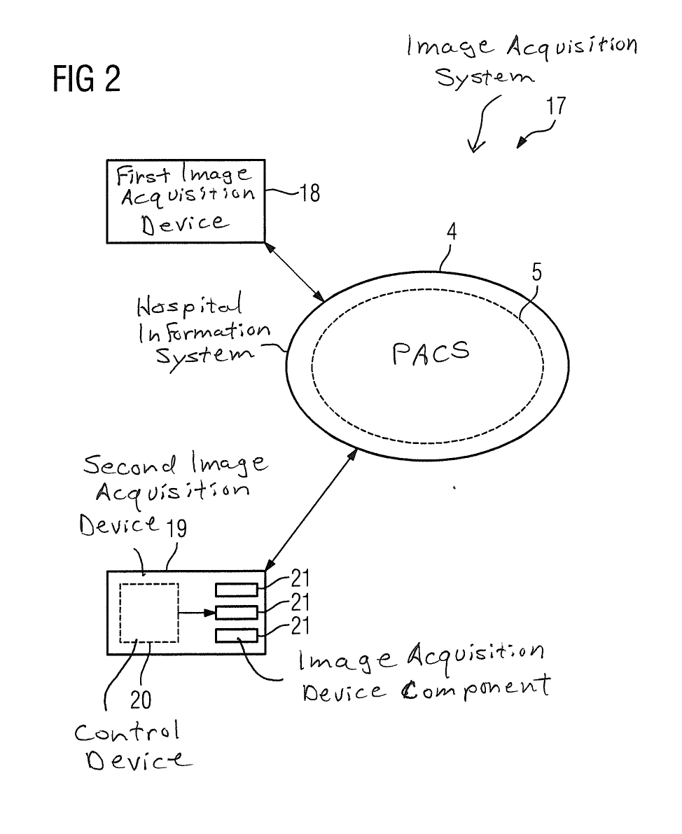

FIG. 2 now shows a principle drawing of a system 17 which also includes an image acquisition device according to the invention.

The first image acquisition device 18 (which in this exemplary embodiment is fashioned as a CT image acquisition device) and the second image acquisition device 19 (which represents an image acquisition device according to the invention and here is fashioned as a magnetic resonance image acquisition device) are connected to the hospital information system 4 including the image archiving system 5.

The second image acquisition device 19 according to the invention has a control device 20 that is designed to implement the method according to the invention and can be controlled with the components 21 of the image acquisition device 19 (among other things the gradient coils, at least one radio-frequency coil, a patient bed and the like in the exemplary embodiment presented here).

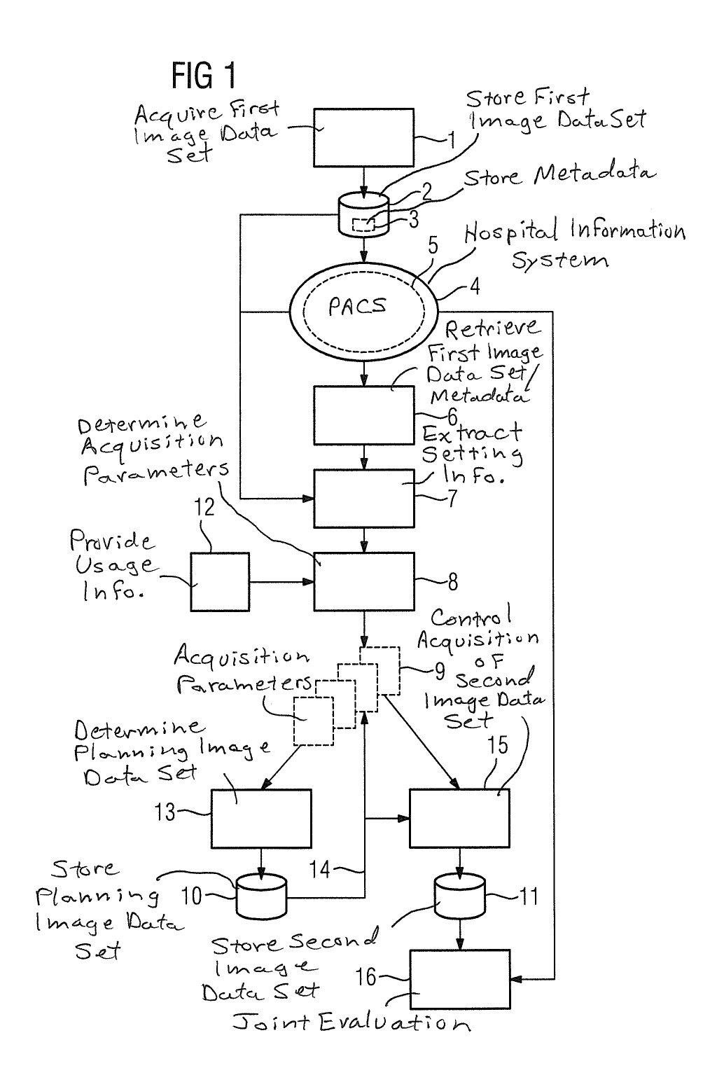

Steps 6, 7, 8, 13 and 15 according to FIG. 1 are consequently executed in the control device 20 in order to be able to acquire a second image data set 11 that is ideally matched to the joint evaluation with the first image data set 2.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for controlling acquisition of medical images, comprising:
providing a computerized processor with a first medical image data set, acquired in a first acquisition by operation of a first medical imaging acquisition device according to a first imaging modality;
in said processor, automatically extracting at least one item of setting information from at least one of said first medical image data set and a metadata set associated with said first medical image data set;
in said processor, automatically determining, from the extracted setting information, at least one acquisition parameter for a second acquisition, selected from the group consisting of a second image data set and a planning image data set, by operation of a second medical image acquisition device according to a second image acquisition modality that is different from said first image acquisition modality, with said at least one acquisition parameter being determined to facilitate joint evaluation of said first medical image data set and an image data set acquired in said second acquisition; and
making said at least one acquisition parameter available at an output of said processor in an electronic form configured to operate said second image acquisition device according to said at least one acquisition parameter.

2. A method as claimed in claim 1 comprising automatically controlling said second image acquisition device to implement said second acquisition according to said at least one acquisition parameter.

3. A method as claimed in claim 1 comprising allowing manual adaptation of said at least one acquisition parameter via a manual entry into said processor.

4. A method as claimed in claim 3 comprising from said processor, causing display of an image corresponding to said first image data set at a display in communication with said processor, and allowing said manual adaptation of said at least one acquisition parameter after displaying said image.

5. A method as claimed in claim 1 comprising employing a computed tomography image acquisition device as said first image acquisition device, and employing a magnetic resonance imaging acquisition device as said second image acquisition device.

6. A method as claimed in claim 1 comprising employing a magnetic resonance image acquisition device as said first image acquisition device and employing a computed tomography image acquisition device as said second image acquisition device.

7. A method as claimed in claim 1 comprising extracting said at least one item of setting information from the group consisting of a resolution of said first image data set, a resolution of said second acquisition, a size and position of a field of view of said first image data set, a size and position of a field of said second acquisition, information describing at least one slice of an examination subject represented in said first image data set, information describing at least one slice of an examination subject represented in said second acquisition, information describing contrast in said first image data set, and information describing contrast in said second acquisition.

8. A method as claimed in claim 1 comprising determining said at least one acquisition parameter from the group consisting of a resolution of said first image data set, a resolution of said second acquisition, a size and position of a field of view of said first image data set, a size and position of a field of said second acquisition, information describing at least one slice of an examination subject represented in said first image data set, information describing at least one slice of an examination subject represented in said second acquisition, information describing contrast in said first image data set, and information describing contrast in said second acquisition.

9. A method as claimed in claim 1 wherein said first image acquisition device comprises a first supporting arrangement configured to support an examination subject in said first image acquisition device during acquisition of said first image data set, and wherein said second image acquisition device comprises a second support arrangement, comparable to said first support arrangement, configured to support said examination subject in said second image acquisition device during said second acquisition, and wherein extracting said at least one item of setting information comprises extracting information from at least one of said first image data set and a metadata set associated with said first image data set describing a setting of said first support arrangement, and wherein determining said at least one acquisition parameter comprises determining a setting instruction for said second support arrangement in said second acquisition that corresponds to said setting of said first support arrangement.

10. A method as claimed in claim 1 comprising electronically storing said first image data set in a memory in a DICOM format together with at least one set of metadata associated with said first image data set, placing said memory in communication with said processor, and reading out, from said processor, at least one of said first image data set and said set of metadata from said memory in order to extract said at least one item of setting information.

11. A method as claimed in claim 10 comprising storing, as said at least one set of metadata, a self-defined set of DICOM metadata.

12. A method as claimed in claim 11 wherein said first image acquisition device comprises a first supporting arrangement configured to support an examination subject in said first image acquisition device during acquisition of said first image data set, and wherein said second image acquisition device comprises a second support arrangement, comparable to said first support arrangement, configured to support said examination subject in said second image acquisition device during said second acquisition, and wherein extracting said at least one item of setting information comprises extracting information from said DICOM metadata set that describes a setting of said first support arrangement, and wherein determining said at least one acquisition parameter comprises determining a setting instruction for said second support arrangement in said second acquisition that corresponds to said setting of said first support arrangement.

13. A method as claimed in claim 1 wherein said second image acquisition device comprises a computerized control unit, and configuring said computerized control unit to have access to at least one of said first image data set and said metadata set associated with said first image data set.

14. A method as claimed in claim 13 comprising storing at least one of said first image data set and said metadata set associated with said first image data set in an image archiving system, and allowing access to said image archiving system by said computerized control unit of said second image acquisition device.

15. A method as claimed in claim 14 comprising also storing said second image data set in said image archiving system.

16. A method as claimed in claim 1 wherein said second image acquisition device comprises a computerized control unit and comprising providing said first imager data set to said computerized control unit of said second image acquisition device and, in said computerized control unit, evaluating said first image data set to implement an automatic slice position adaptation, for acquiring image data from a slice of an examination subject, in said second acquisition.

17. A method as claimed in claim 1 wherein said determining of said at least acquisition parameter for said second acquisition comprises determining at least one acquisition parameter for a planning image data set as said second acquisition, and wherein said second image data acquisition device comprises a computerized control unit, and comprising, in said computerized control unit, evaluating said planning image data set in order to implement an automated slice position adaptation for acquiring image data from a slice of an examination subject with said second image acquisition device.

18. A method as claimed in claim 1 wherein said second image acquisition device has image acquisition limitations associated therewith, and comprising, in said processor, determining said at least one acquisition parameter dependent on said limitations.

19. A method as claimed in claim 18 comprising, within said limitations, determining said at least one acquisition parameter as a parameter that optimizes said joint evaluation of said first image data set and second acquisition.

20. A medical image acquisition system comprising:
a computerized processor provided with a first medical image data set, acquired in a first acquisition by operation of a first medical imaging acquisition device according to a first imaging modality;
said processor being configured to automatically extract at least one item of setting information from at least one of said first medical image data set and a metadata set associated with said first medical image data set;
a second medical image acquisition device that operates according to a second image acquisition modality that is different from said first image acquisition modality;
said processor automatically being configured to determine, from the extracted setting information, at least one acquisition parameter for a second acquisition, selected from the group consisting of a second image data set and a planning image data set, by operation of said second medical image acquisition device according to said second image acquisition modality, with said at least one acquisition parameter being determined to facilitate joint evaluation of said first medical image data set and an image data set acquired in said second acquisition; and
said processor being configured to make said at least one acquisition parameter available at an output of said processor in an electronic form configured to operate said second image acquisition device according to said at least one acquisition parameter.
